(19) United States
(12) Patent Application Publication
(10) Pub. No.: US 2015/0039708 A1
(43) Pub. Date: Feb. 5, 2015

(54) METHOD AND APPARATUS FOR PROCESSING A MESSAGE

(71) Applicant: TENCENT TECHNOLOGY (SHENZHEN) COMPANY LIMITED, Shenzhen Guangdong (CN)

(72) Inventor: Zhongshu Liu, Shenzhen Guangdong (CN)

(21) Appl. No.: 14/384,631

(22) PCT Filed: Feb. 21, 2013
(86) PCT No.: PCT/CN2013/071717

§ 371 Date: Sep. 11, 2014

(30) Foreign Application Priority Data
Mar. 16, 2012 (CN) 201210069809.0

(51) Int. Cl. H04L 12/58

(52) U.S. Cl. CPC H04L 51/24; H04L 51/04
USPC 709/206

(57) ABSTRACT

An apparatus and method to process a message in a network communication is provided. An example method for processing a message may include determining, by a message transmitter, a key recipient of a message to be transmitted and adding a key identifier of the key recipient to the message. The method may further involve transmitting the message in the communication group. Upon receiving the message at a message receiver in the communication group transmitted by the message transmitter, it may be determined whether a recipient corresponding to the message receiver is the key recipient of the message. If the recipient corresponding to the message is the key recipient, the message receiver may display the message as an important message; and otherwise, display the message as a non-important message.

This application is a continuation application of PCT international application PCT/CN2013/071717, filed on Feb. 21, 2013, which claims the priority of Chinese Patent Application No. 201210069809.0, entitled “METHOD AND APPARATUS FOR PROCESSING A MESSAGE”, filed with the Chinese Patent Office on Mar. 16, 2012, both of which are incorporated herein by reference in their entirety.

### FIELD OF THE INVENTION

The present invention relates to network communications techniques, and more particularly, to a method and an apparatus for processing a message.

### BACKGROUND OF THE INVENTION

In network communications, a communication group may involve several users communicating with each other. In the communication group, all group members may receive a message transmitted by any group member. Communication groups may be categorized into two kinds of communication groups, an Instant Messaging (IM) communication group and a non-IM communication group. Examples of IM tools include QQ, MSN, RTX, Fetion, etc., and examples of corresponding IM communication groups are QQ group, MSN group, RTX group and WeChat group respectively. A typical non-IM tool is e-mail and the corresponding communication group is a mail group.

For the IM group and the non-IM group, when a group member (referred to as a recipient) receives a message at a message receiver device (e.g., a mobile device, desktop computer, tablet computer) transmitted by another group member (referred to as a sender) from a message transmitter device (e.g., another mobile device, personal computer, tablet computer), the message may be displayed on the message receiver device in a manner configured by the recipient. The message transmitter may not be able to control the message receiver device to display the message in a certain manner.

As a consequence, the recipient may miss some important messages.

### SUMMARY OF THE INVENTION

Examples of the present invention provide a method and an apparatus for processing a message, so as to enable a message transmitter to control a display manner of a message at a message receiver device and avoid the recipient from missing the message or replying to the message.

According to an example of the present disclosure, a method for processing a message is provided. The method may include determining, by a message transmitter device, a key recipient of a message to be transmitted in a communication group. The message may further involve adding, in the message to be transmitted, by the message transmitter device, a key identifier for the key recipient and transmitting the message in the communication group. A message receiver device in the communication group, upon receiving the message transmitted by the message transmitter, may determine, based on the key identifier in the message, whether a recipient corresponding to the message receiver device is the key recipient of the message. If the recipient corresponding to the message receiver device is the key recipient, the method may continue by displaying the message as an important message; and otherwise, displaying the message as a non-important message.

According to another example of the present disclosure, an apparatus for processing a message is provided. The apparatus may include a processing module to determine a key recipient of a message to be transmitted. The apparatus may also include a transmitting module that may add a key identifier of the key recipient in the message to be transmitted and transmit the message containing the key identifier in a communication group.

According to another example of the present disclosure, an apparatus for processing a message is provided. The apparatus may include a receiving module, to receive a message transmitted by a message transmitter of a communication group. A determining module of the apparatus may determine, based on the key identifier in the message, whether a recipient corresponding to the message receiver is the key recipient of the message. A displaying module may display the message indicating the message as an important message if the determining module determines that the recipient corresponding to the message receiver is the key recipient of the message. Otherwise, the displaying module may display the message as a non-important message.

Thus, in examples of the present disclosure, the key recipient to be specially notified of a message may be determined by the message transmitter in the communication group, and a key identifier of the key recipient may be added in the message to be transmitted. The message containing the key identifier may be subsequently transmitted in a communication group. Upon receiving the message, the message receiver may determine, based on the key identifier in the message, whether a message recipient corresponding to the message receiver is the key recipient of the message. If the corresponding message recipient is the key recipient, the message may be displayed as an important message; otherwise, the message may be displayed normally, or as a non-important message. This may enable the message transmitter to control the manner in which the message is displayed at the message receiver. Thus, the key recipient may receive the message distinctly, so as to avoid missing the message.

### BRIEF DESCRIPTION OF THE DRAWINGS

FIG. 1 is a flowchart illustrating a method for processing a message according to an example of the present disclosure.

FIG. 2 is a flowchart illustrating a method for transmitting a message according to an example of the present disclosure.

FIG. 3 is a flowchart illustrating a method for receiving a message according to an example of the present disclosure.

FIG. 4 is a schematic diagram illustrating a structure of a message transmitter and a message receiver for processing a message according to an example of the present invention.

### DETAILED DESCRIPTION OF THE INVENTION

The present disclosure is described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

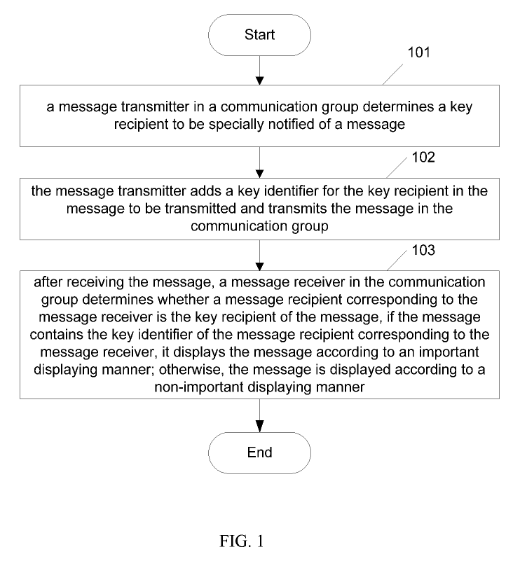

FIG. 1 is a flowchart illustrating a method for processing a message according to an example of the present invention. As shown in FIG. 1, the method may include at least the following steps.

At block 101, a message transmitter in a communication group may determine a key recipient to be specially notified of a message. The key recipient may be a group member of the communication group. The key recipient may be someone who is highly related to the message, or may be a group member selected as being a key recipient based on other criteria.

In block 101, the communication group may be an IM group or a non-IM group, or any other type of communication group.

In addition, the message transmitter may determine the key recipient according to content of the message to be transmitted, e.g., which recipient that the message to be transmitted specially aims at.

At block 102, the message transmitter may add a key identifier for the key recipient in the message to be transmitted and transmits the message in the communication group.

In block 102, adding the key identifier of the key recipient may include adding a predefined keyword to an identity of the key recipient. The resulting message may be a composite message including the key identifier of the intended key recipient and the message itself

The identity of the key recipient may be determined according to the type of the communication group. For example, if the communication group is a QQ group, the identity of the key recipient may be a QQ account of the key recipient. If the communication group is a mail group, the identity of the key recipient may be an e-mail address of the key recipient. In addition, the predefined keyword may include but is not limited to: @, “”, or other symbols or keywords defined by users. The predefined keyword may be used for indicating that the message has a key recipient.

Suppose that the keyword is @, user A is a key recipient to be specially notified of the message and the content of the message to be transmitted is “when does the meeting begin?” Then, in block 102, the message transmitted, i.e. the composite message is “@user A, when does the meeting begin?”

At block 103, after receiving the message, a message receiver in the communication group may determine whether a message recipient corresponding to the message receiver is the key recipient of the message. In other words, the message receiver may determine whether the message contains a key identifier that identifies the message recipient corresponding to the message receiver as the key recipient from among the members of the communication group. If the message contains the key identifier of the message recipient corresponding to the message receiver, the message may be displayed to signify an importance of the message. Instead, if the message recipient corresponding to the message receiver is not the key recipient, the message may be displayed like a normal or a non-important message.

In block 103, the non-important displaying manner, or a normal displaying manner, may be substantially similar to a conventional display. The important displaying manner i.e. displaying the message as an important one, may remind the key recipient of the message and thus avoid missing the message. Different from the non-important displaying manner, the important displaying manner may display the message in a relatively attractive way, e.g., highlighting the message, flickering the message on display, or displaying the message independent from the communication group, or any other way of indicating the importance or significance of the message.

The method may end after block 103.

The method as shown in FIG. 1 will be described in further detail below with reference to an example.

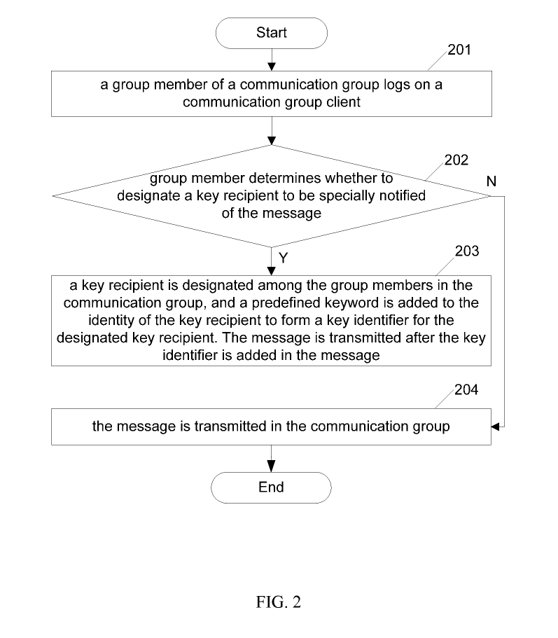

FIG. 2 is a flowchart illustrating a method for transmitting a message according to an example of the present invention. As shown in FIG. 2, the flow corresponds to the descriptions of above blocks 101 and 102 and may include the following steps.

At block 201, a group member of the communication group may log on a communication group client.

Further, in block 201, an account or any combination of an account, a password and a verification code may be required to log on the communication group client. The communication group client may be a QQ group client, a mail group client or a RTX group client, or any other communication group client.

At block 202, before transmitting a message as a sender, the group member of the communication group may determine whether it is required to designate a key recipient to be specially notified of the message. If it is required to designate a key recipient, block 203 may be performed; otherwise, block 204 may be performed.

At block 203, a key recipient may be designated among the group members in the communication group, and a predefined keyword may be added to the identity of the key recipient to form a key identifier for the designated key recipient. The message may then be transmitted after the key identifier is added in the message.

Suppose that the keyword is @, user A is a key recipient of the message and the content of the message to be transmitted is “when does the meeting begin?” Then, in block 203, the message transmitted, in such a case, may be “@user A, when does the meeting begin?”

At block 204, the message may be transmitted to the users in the communication group.

Thus, in the above example where the content of the message to be transmitted is “when does the meeting begin?”, in block 204, the message finally transmitted to the group would be “when does the meeting begin?”

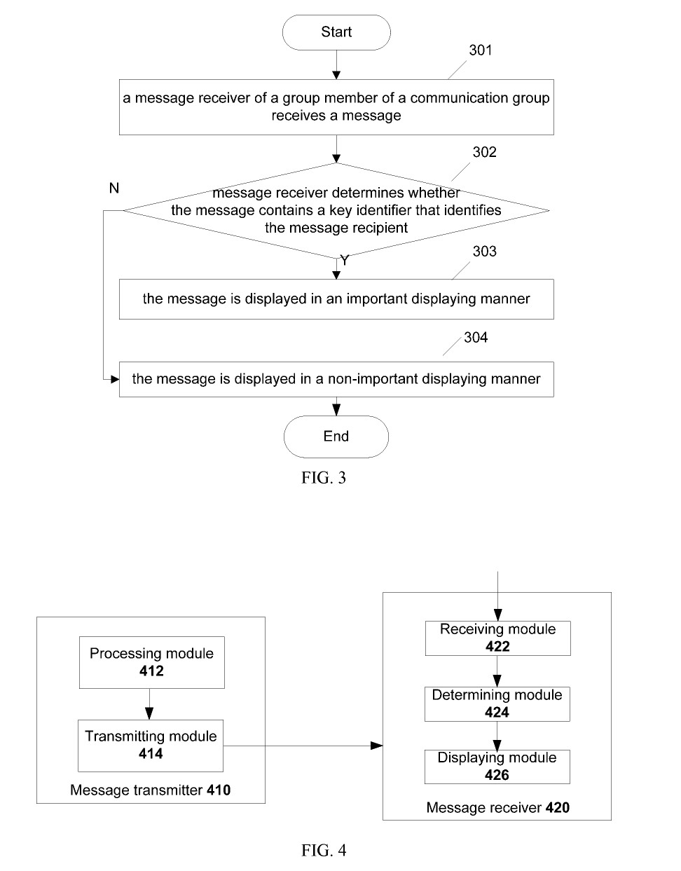

FIG. 3 is a flowchart illustrating a method for receiving a message according to an example of the present disclosure. As shown in FIG. 3, the flow may correspond to the above block 103 and may include the following steps.

At block 301, a message receiver of a group member of a communication group may receive a message. The group member may act as a message recipient.

At block 302, the message receiver may determine whether the message contains a key identifier that identifies the message recipient (i.e., whether the message contains an identity of the message recipient and a predefined keyword). If the message contains the key identifier of the message recipient, block 303 may be performed;

otherwise, block 304 may be performed.

At block 303, the message may be displayed as an important message.

At block 304, the message may be displayed as a non-important message.

In block 304, displaying a non-important message may be equivalent to displaying a conventional message. The displaying manner, to mark the message as important in block 303, may be utilized to remind the key recipient of the message and avoid missing the message. Different from the displaying manner of a non-important message, indicated in block 304, the displaying manner of an important message may display the message in a relatively attractive way, e.g., by highlighting the message, flickering the message on display, or displaying the message independent from the communication group. There may be other possible techniques to mark the message important that are commonly known in the art and would be obvious to a person of ordinary skill in the art.

In addition, before block 303 or block 304, the method may further include removing the key identifier in the message. Thus, other message recipients may not know the key recipient, which may ensure that each message recipient processes the message independently.

It can be seen from the solution as shown in FIG. 1 to FIG. 3 that, in examples of the present disclosure, the key recipient may be determined by the message transmitter. The message transmitter may add a key identifier of the key recipient to the message to be transmitted. Upon receiving the message, the message receiver may determine whether the message contains the key identifier of the message recipient corresponding to the message receiver, so as to determine whether the message recipient is the key recipient. If the message recipient is the key recipient, the message may be displayed as an important message; otherwise, the message may be displayed normally according to a conventional manner. The solution of the present disclosure, thus, may enable the message transmitter to control the displaying manner of the message. The key recipient may be reminded of the message, so as to avoid missing the message.

Hereinafter, the apparatus provided by the present invention will be described.

FIG. 4 is a schematic diagram illustrating a message transmitter and a message receiver for processing a message according to an example of the present disclosure. As shown in FIG. 4, the message transmitter 410 may include a processing module 412 and a transmitting module 414.

The processing module 412 may determine a key recipient of a message to be transmitted.

The transmitting module 414 may add a key identifier for the key recipient in the message to be transmitted. The transmitting module 414 may further transmit the message containing the key identifier to group members in a communication group.

In one example, the key identifier added by the transmitting module 414 to the message to be transmitted may include an identity of the key recipient and a predefined keyword.

As shown in FIG. 4, the message transmitter 420 may include a receiving module 422, a determining module 424 and a displaying module 426.

The receiving module 422 may receive the message transmitted by a message transmitter in the communication group.

The determining module 424 may determine whether the key recipient identified by the key identifier in the message is the message recipient corresponding to the message receiver.

The displaying module 426 may display the message. The message may be displayed as an important message if the determining module 424 determines that the message recipient corresponding to the message receiver is the key recipient of the message. The displaying module 426 may, instead, display the message as a non-important, or regular, or conventional message if the key identifier in the message is not the message recipient corresponding to the message receiver.

Displaying the message as an important message may include highlighting the message, flickering the message, or displaying the message independent from the communication group. Further ways to indicate an importance of the message may be available.

The displaying module 426 may further remove the key identifier before displaying the message.

In examples of the present disclosure, the communication group may be an IM group or a non-IM group.

It can be seen from the above solution that, in examples of the present disclosure, the key recipient may be determined by the message transmitter 410. The message transmitter 410 may add a key identifier corresponding to the key recipient to the message to be transmitted. Upon receiving the message, the message receiver 420 may determine whether the message contains a key identifier, and if so, whether the key identifier identifies a message recipient corresponding to the message receiver so as to determine whether the message recipient is the key recipient. If the message recipient corresponding to the message receiver 420 is the key recipient, the message may be displayed in a displaying manner to indicate the message as an important message; otherwise, the message may be displayed normally according to a conventional displaying manner. The examples of the present disclosure, thus, may enable the message transmitter 410 to control the displaying manner of the message at the message receiver 420. Thus, the key recipient may receive the message distinctly, so as to avoid missing the message.

The message transmitter 410 as shown in FIG. 4 may include a processor and a memory; wherein the memory may be communicatively connected to the processor. The memory may be a non-transitory computer readable medium. The memory may store machine readable instructions. The instructions may be executable by the processor to perform the functions of the processing module 412 and the transmitting module 414.

The message receiver 420 as shown in FIG. 4 may include a processor and a memory; the memory communicatively connected to the processor. The memory may be a non-transitory computer readable medium and may store machine readable instructions executable by the processor to perform the functions of the receiving module 422, the determining module 424, and the displaying module 426.

The above examples may be implemented by hardware, software, firmware, or a combination thereof For example the various methods, processes and functional modules described herein may be implemented by a processor (the term processor is to be interpreted broadly to include a CPU, processing module, Application Specific Integrated Circuit (ASIC), logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof Further, the examples disclosed herein may be implemented in the form of a software product. The computer software product is stored in a non-transitory storage medium and comprises a plurality of instructions for making a computer device (which may be a personal computer, a server or a network device, etc.) implement the method recited in the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A method for processing a message, comprising:
determining, by a message transmitter, a key recipient of a message to be transmitted to a communication group;
adding, by the message transmitter, to the message to be transmitted, an identifier of said key recipient to create a composite message, transmitting said composite message to the communication group;
receiving, by a message receiver, the composite message transmitted by the message transmitter;
determining, by said message receiver, based on the key identifier in the composite message, whether a recipient corresponding to said message receiver is a key recipient; and
if the recipient is a key recipient, displaying the message in one fashion indicating the message as important, and if the recipient is not a key recipient, displaying the message as a non-important message.

2. The method of claim 1, wherein adding the key identifier to the message to be transmitted comprises:
adding a predefined keyword and an identity of the key recipient to the message to be transmitted.

3. The method of claim 2, wherein the identity of the key recipient is an Instant Messaging (IM) account name of the key recipient or a mail address of the key recipient.

4. The method of claim 1, wherein displaying the message as an important message comprises at least one of:
highlighting the message, flickering the message, or displaying the message independent from the communication group.

5. The method of claim 1, further comprising:
before displaying the message, removing the key identifier in the composite message.

6. An apparatus for processing a message, comprising:
a processing module, configured to determine a key recipient of a message to be transmitted; and
a transmitting module, configured to add a key identifier of the key recipient to the message to be transmitted and further configured to transmit the message containing the key identifier to a communication group.

7. The apparatus of claim 6, wherein the transmitting module is further configured to add a predefined keyword to an identity of the key recipient in the message to be transmitted.

8. The apparatus of claim 7, wherein the identity of the key recipient indicates an Instant Messaging (IM) account of the key recipient or a mail address of the key recipient.

9. An apparatus for processing a message on a message receiver, comprising:
a receiving module, configured to receive the message transmitted by a message transmitter to a communication group;
a determining module, configured to determine, based on a key identifier in the message, whether a recipient corresponding to the message receiver is the key recipient of the message; and
a displaying module, configured to display the message to indicate the message as important in response to a determination by the determining module that the recipient corresponding to the message receiver is the key recipient of the message, and to display the message as a non-important displaying manner otherwise.

10. The apparatus of claim 9, wherein the displaying module is further configured to highlight the message, display the message flickeringly, and display the message independent from the communication group.

11. The apparatus of claim 9, wherein the displaying module is further configured to remove the key identifier in the message before displaying the message.
